(19) United States
(12) Patent Application Publication
(10) Pub. No.: US 2002/0024813 A1
(43) Pub. Date: Feb. 28, 2002

(54) Extruded parts, member including the extruded parts for forming lamp housing for light curing system, apparatus using such member, and method of manufacturing and using such parts

(76) Inventors: William Bonham, Ijamsville, MD (US); John Phillips, Frederick, MD (US); John C. Galloway, Ellicott City, MD (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/832,126

(22) Filed: Apr. 11, 2001

Related U.S. Application Data
(60) Provisional application No. 60/196,108, filed on Apr. 11, 2000.

(51) Int. Cl. F21V 29/00

(52) U.S. Cl. 362/294; 362/92

(57) ABSTRACT

Provided are lamp systems, such as ultraviolet light curing systems, having lamp modules, components of such lamp modules, and methods of manufacturing such components and of using such lamp systems. Each lamp module includes a housing for, e.g., a row of lamps, formed of parts formed by extrusion and having end plates on the extrusion parts. The extrusion parts provide supports for replaceable or changeable quartz plates, replaceable or changeable chill beds and/or heat shields, and replaceable or changeable lamps. The extrusion parts also form air intake and air exhaust structures for cooling the lamp modules; and vanes are provided in the air intake structure, and sinusoidal surfaces are provided at the inlet to and outlet from the housing for material to be treated (e.g., a web having a coating thereon), to act as light traps to at least reduce light leakage from the housing.

This application claims priority under 35 USC 119(e)(1) of prior provisional application Ser. No. 60/196,108, filed Apr. 11, 2000, the contents of which are incorporated herein by reference in their entirety.

### BACKGROUND

The present invention is directed to extruded parts; and to members, containing the extruded parts, for forming housings for lamp systems, for example, housings for ultraviolet lamp systems, useful for a variety of applications such as (but not limited to) curing a coating (for example, a resin coating) on a web. More specifically, the present invention is directed to such extruded parts and members, and use of such parts and members for various methods and in various apparatuses, for providing housings for lamp systems providing light (e.g., ultraviolet light) to cure light-curable resins (for example, ultraviolet light-curable resin coatings on a web).

The present invention is also directed to housings formed using such members, lamp modules and lamp (irradiating) systems using such housings, and methods of manufacturing such members and using such lamp systems for applications such as curing.

The present invention is additionally directed to members useable to retrofit already existing lamp systems, e.g., for existing manufacturing lines for curing ultraviolet light-curable resin coatings on a web.

While the present invention is discussed primarily in connection with ultraviolet light-producing lamp systems to cure ultraviolet light-curable resins, the present invention is not limited thereto, and can be applied to, for example, lamp systems having lamps producing other types of light (such as infrared and visible light), and for purposes other than curing resins.

Prior housings for lamp systems consist of apparatus, usually provided as one manufactured piece, like a box, provided by welding, engineered specifically for a particular application, e.g., for a specific customer. These units are not adaptable to a variety of process widths and are not modular. Previously, customers and suppliers focused on specific equipment to resolve the specific need for a particular application. Moreover, in view of possible future needs including expanded size of apparatus, customers usually requested to have a product made considerably larger than immediate needs. Thus, prior designs would be of a fixed design unit that is non-modular and not adaptable or flexible for process changes, or useable for a variety of applications.

Thus, a major problem arising in connection with prior systems was the lack of flexibility in the apparatus, for use for a variety of applications or different processes, or in connection with different size operations.

### SUMMARY

Applicants provide structure, and the manufacture and use of such structure, having great flexibility, while providing an apparatus which is safe notwithstanding intense light levels for curing and use of microwaves in the apparatus, and which is simple to manufacture. Applicants have found that the above problem and others are overcome by providing a modular basis for the housing for ultraviolet lamps in customer processes, the housing including extruded parts, with members for the housing being formed with these extruded parts. Lamp housings and process equipment using these members can be in various lengths, to cover a variety of process widths (e.g., a variety of widths of webs being irradiated by light from the lamps), using members initially of a same width. Moreover, the equipment ends (that is, end plates) for all of the various lengths utilized for the housings can be common for all sizes.

Moreover, according to various features of the present invention, small apparatus dimensions, including avoidance of external snouts for reducing leakage of light from the interior of the housing, can be achieved. The extrusion structure according to the present invention allows great application flexibility.

According to an aspect of the present invention, parts or components of the members are formed by extrusion of material (for example, extrusion of metal material, such as aluminum-containing material) of the members. Each member, when the components thereof are combined together, extends in a lengthwise direction, has a support for holding at least one lamp (preferably, a row of lamps which include at least two lamps), and provides an inlet and outlet for material to be irradiated with energy (for example, ultraviolet light, infrared light and/or visible light) for, e.g., curing the material. Each member includes gas intake structure and gas exhaust structure for passing cooling gas to within the member (in particular, when the member forms a housing for the lamps, the gas intake and gas exhaust structure pass cooling gas to within the housing for cooling purposes). The cooling gas (e.g., air) passes by the lamps and housing portions adjacent thereto to help cool the lamps and housing; and the cooling gas can also be passed to the location where the material is irradiated, to cool the housing and other structure (as well as the irradiated material) at such location. That is, the cooling gas is used to cool the housing and lamps during operation of the lamp system.

Each member can include a first part having the gas intake structure, a second part having the gas exhaust structure and at least one third, lower part beneath the first and second parts. When the at least one third, lower part is fastened (e.g., by bolts) to the first and second parts, an inlet and outlet for material treated (e.g., cured) by light from the lamps is provided between the first and second parts, on the one hand, and the third part, on the other. Material irradiated (for example, a light-curable resin or polymer) can be supported on a web, with the web passing from the inlet to the outlet through the housing formed from the member, to irradiate the material and, for example, cure the resin or polymer.

Desirably, each of the first through third parts as mentioned herein extend in a lengthwise direction (which, when the member is formed into a housing and used in a lamp system, this lengthwise direction, for example, extends across the width of the aforementioned web), with the inlet and outlet respectively in the front and rear of the member, and each of these first through third parts is formed by extrusion. Illustratively, the first and second parts are fastened at the front and rear of the at least one third part, providing the member.

The housing formed from this member, according to an aspect of the present invention, includes end plates at both ends of the member, in the aforementioned lengthwise direction. Great flexibility is provided by this structure in that extruded parts of a single length can be formed, and such parts can be cut to desired lengths at requests of the customer. The end plates can then be provided to form the housing, the end plates being useable with housings of different lengths.

According to another aspect of the present invention, the present invention provides additional support structure, for supporting other components of the modular lamp system than the lamps. For example, the member can include a second support for removably supporting a device for removing heat, and/or for removably supporting a heat shield, positioned, for example, at the bottom of the housing where the lamps are provided at the top (or at the top of the housing where the lamps are provided at the bottom); that is, the lamp support and this second support sandwich the path for the material being irradiated. The supports formed by the extruded structure also can include a third support for removably supporting a quartz sheet (e.g., window) which is transparent to radiation from the lamps, this third support being positioned between the lamp support and the path for the material. These supports, e.g., being ledges or channels in the extruded parts, can easily, accurately and effectively be provided by extrusion.

According to a further aspect of the present invention, the inlet and outlet for material irradiated includes an opening in the housing, extending internally into the housing, with the opening (as extending into the housing) being defined by a boundary surface above and below the opening, each boundary surface above and below each of the inlet and the outlet having a sinusoidal shape. This sinusoidal shape acts as a light trap, for preventing light from escaping from the interior of the housing during operation of the lamps. Through use of these boundary surfaces, which constitute an interior trap or snout for the apparatus, an external snout for trapping the light is not required, whereby dimensions of the lamp housing can be reduced (that is, the width of the lamp housing, in the direction that material to be irradiated by the lamps travels, can be reduced). The exterior snouts (exterior light traps) can still be utilized in accordance with the present invention, further reducing amount of light escaping from the housing.

Such sinusoidal shape for the boundary surfaces of the inlet and outlet to the housing can easily be manufactured by extrusion (the sinusoidal shape in cross section extending a length of the member in the lengthwise direction), and is practically impossible to provide by other techniques (for example, by machining).

According to still further aspects of the present invention, the gas intake structure includes a duct having a plurality of vanes extending into the duct from opposed regions of the duct such that, in plan view, the vanes overlap each other; preferably, the vanes overlap such that all straight line paths through the duct of the gas intake structure contact at least one vane, for preventing escape of light. The gas intake structure including such duct with the vanes, preferably providing overlapping of vanes in all directions within the duct (for example, horizontal and vertical directions, as well as other directions) can be easily manufactured by extrusion, while practically impossible to manufacture by other means such as machining.

Preferably, the vanes and sinusoidal surfaces mentioned in the foregoing are painted with a flat black paint, to further avoid escape of light from the housing and to further improve effectiveness of the structures as a light trap (both from the inlet and outlet and from the gas intake structure).

According to a further aspect of the present invention, the extruded parts of the member, formed into the housing, have grooves provided along outer sides thereof, extending in the lengthwise direction, for connecting or removably attaching two housings, so that material can pass through a plurality of housings in series. This provides even greater flexibility in that a plurality of rows of lamps (each housing providing, for example, a single row of lamps) can be utilized to provide, for example, further curing.

According to additional aspects of the present invention, the housing provided for the lamps has end plates at each end of the member. These end plates can be bolted to respective ends of the members, and, desirably, at least one of these end plates is easily opened (for example, is provided on hinges so as to act as a door) for easy access to the interior of the housing (for example, to removably replace a quartz window or to substitute a chill bed or heat shield for louvers at the bottom of the housing where the lamps are at the top of the housing). In addition, according to an aspect of the present invention there is great flexibility in that parts or components of the member can be extruded to a single length, which can then be cut to a length specified by the customer and provided with end plates to provide the housing for the lamps, as ordered by the customer.

As an additional aspect of the present invention, there is a lamp module including the above-mentioned housing of the member and end plates, together with at least one lamp supported by the housing. Additional flexibility for the present structure is provided in that, by providing suitable clamping structure for the lamp, the housing can be inverted such that the lamp is on the bottom with the material irradiated thereabove (or, for example, the housing extends vertically with the lamps irradiating light in a horizontal direction). The lamps are prevented from falling off the housing by, for example, clamping the lamps to the housing. Where the lamps are on top and, e.g., irradiate light downward, gravity can hold the lamps in proper positioning, although brackets for holding the lamp also can be provided in this aspect of the present invention.

As indicated previously, the lamps used can be ultraviolet lamps, such as microwave-powered electrodeless ultraviolet lamps, although the present invention is not limited thereto. For example, other types of ultraviolet lamps such as arc lamps, and/or lamps producing infrared and/or visible light, can also be used, depending upon desires of the customers.

According to still further aspects of the present invention, the structure includes the lamp module and conveying structure to support and move material from the inlet to the outlet of the housing, through the location where the material is irradiated with the light. Illustratively, the conveying structure can be a web which passes through the housing from the inlet to the outlet, and, for example, the material irradiated can be a coating of a polymer or resin material on the web. As mentioned previously, a plurality of rows of lamps can be provided side-by-side, to provide a plurality of rows of lamps for curing; and some of the housings of the plurality of rows can shine on the upper surface of the web and others shine on the lower surface of the web, to, for example, cure coatings on both surfaces of the web during one pass of the web.

The present invention, as a further aspect thereof, is also directed to a method of making the aforementioned parts and members. This method includes extrusions of material of each part of the member through respective extruders to form the different parts or components (for example, to form a gas intake extrusion having the gas intake structure, a gas exhaust extrusion having the gas exhaust structure, and a bottom extrusion), and then fastening these extrusions to each other to provide the member which can, for example, be cut to desired lengths according to desires of the customer and provided with the aforementioned end plates to provide a housing for the lamps.

As a desired feature according to manufacture of the member, in manufacturing the gas intake extrusion a bridge is maintained in the interior at the end of the gas intake duct, during the extrusion, in order to provide reinforcement during the extrusion. Thereafter, this bridge of material can be machined out, for example, when machining out the opposed (outer) surface of the duct to form slots, so as to provide the necessary gas passage through the gas intake duct.

According to still further aspects of the present invention, the module or assembly according to the present invention includes the housing and lamps; and further, in the lamp system according to the present invention the module or assembly is further provided with conveying structure, and this lamp system can illustratively (and not to be limiting) be used in curing a resin material. The resin material, to be cured, can be provided on the conveying structure and is conveyed thereon to the location where the material is irradiated with light from the lamps, to cure the resin material. Illustratively, the material can be an ultraviolet light curable resin material, with lamps providing ultraviolet light to cure the material.

Accordingly, by the various aspects of the present invention, wherein parts or components of the member are formed by extrusion, the structure can easily and accurately be provided, with a great deal of flexibility with respect to length and other dimensions of the structure. Furthermore, through use of the sinusoidal structure at the entrance and exit for, e.g., the web supporting the material to be cured, light is effectively trapped, so that structure without exterior snouts to trap light can be utilized, decreasing size of the apparatus, whereby the structure can be provided with a reduced size (e.g., reduced width); such sinusoidal structure can practically only be provided by extrusion.

Moreover, through use of the vanes in the gas intake structure, improved trapping of light is achieved so as to reduce undesired escape of light through the gas intake duct. Moreover, these vanes and duct structure can easily be provided by extrusion.

Furthermore, through use of the extrusion technique, various supports can be provided within the housing so that components, easily removable, can be provided for the structure. For example, a removable quartz tray holding a quartz window can easily be provided between the lamp and web, providing a simplified structure whereby the quartz window and tray can easily be changed. In addition, through use of the support at the, e.g., bottom of the housing where the lamps are provided at the top, a chill bed, or louvers for air flow, or a heat shield, can be provided and easily changed, for example, at the location of the customer.

Moreover, due to use of the extrusion it becomes easy to form ridges in both the inlet of the gas intake duct and outlet of the gas exhaust duct, to provide locations to retain RF screens in the gas intake duct and gas exhaust duct in order to retain RF radiation within the structure, maintaining safety of the structure. In addition, through use of the vanes, formed by extrusion, the screen for the gas intake duct can be positioned at the vanes, so as to easily and effectively retain the screen in the structure.

Furthermore, through use of the vane structure, good flow of cooling gas (for example, air, having a low pressure drop in the air delivery) is achieved.

In addition, according to another aspect of the present invention, component parts of the housing of the present invention can be used as a retrofit unit, used with parts of an existing customer system. The retrofit unit can include, for example, the gas intake extrusion and gas exhaust extrusion, bolted to existing structure to provide an inlet and an outlet, for the material irradiated, between the existing structure and the gas intake and exhaust extrusions. Thus, a simple retrofit unit can be achieved to, for example, add ultraviolet lamps to a system, without totally changing the system.

### BRIEF DESCRIPTION OF THE DRAWINGS

FIG. 1 is an exploded perspective view of a lamp module of the present invention, to have lamps positioned over a web (so-called top cure assembly) according to an embodiment of the present invention.

FIG. 2 is a cross-sectional view transverse to the lengthwise direction of the irradiating structure, according to an embodiment of the present invention.

FIG. 3 is a top plan view of gas intake and gas exhaust extrusions according to an embodiment of the present invention.

FIG. 4 is a cross-sectional schematic view showing gas intake structure according to an embodiment of the present invention.

FIG. 5 is a cross-sectional schematic view showing gas exhaust structure according to an embodiment of the present invention.

FIG. 6 is a cross-sectional schematic view showing bottom extrusion structure according to an embodiment of the present invention.

FIGS. 7(a)-7(d) schematically show single and plural lamp modules for a web for top curing, according to aspects of the present invention.

FIGS. 8(a) and 8(b) schematically show single and plural lamp modules for a web for bottom curing, according to aspects of the present invention.

FIGS. 9(a)-9(c) show lamp modules for both top and bottom curing assembled together for a same web, according to aspects of the present invention.

FIG. 10 is a cross-sectional schematic view showing extruded parts forming gas intake and gas exhaust structures as structure above a web, providing inlet and outlet for the web, which can be retrofit on an existing system having, for example, a box structure holding a heat shield or chill bed or louvers below the web.

### DETAILED DESCRIPTION

While the invention will be described in connection with specific examples and illustrative embodiments, it will be understood that it is not intended to limit the invention to these described examples and illustrative embodiments. To the contrary, it is intended to cover all alterations, modifications and equivalents as may be included within the spirit and scope of the invention as defined by the appended claims.

Examples and illustrative embodiments of the present invention, in the following, are described in connection with the various drawing figures. The various components in the drawing figures having corresponding functions are referred to using common reference numerals.

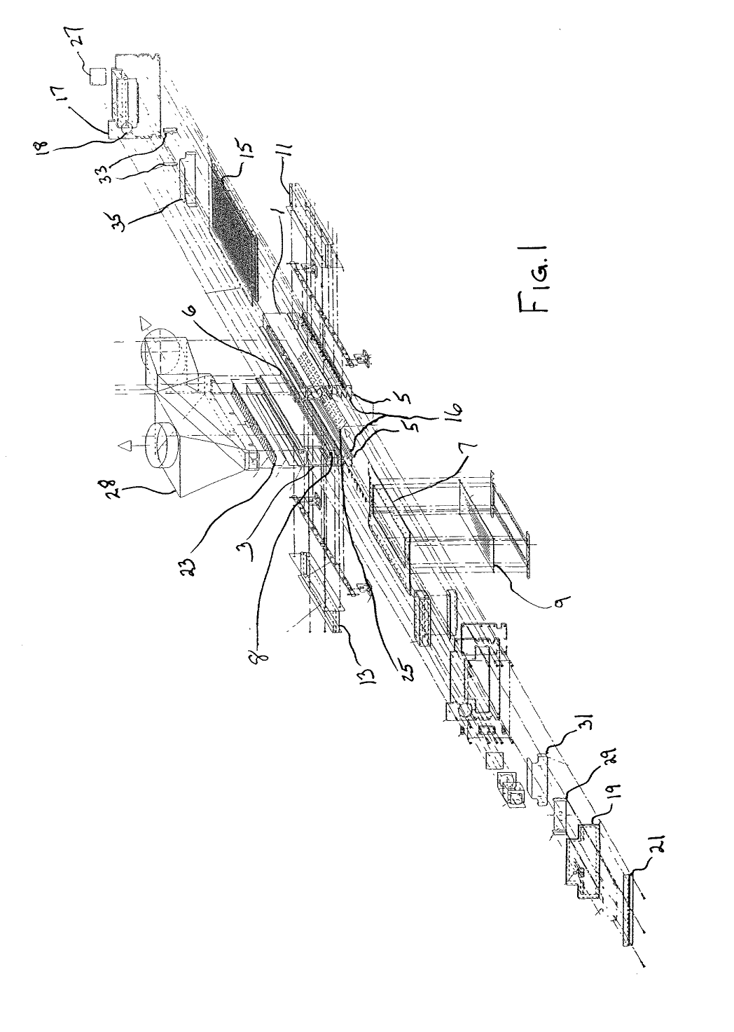

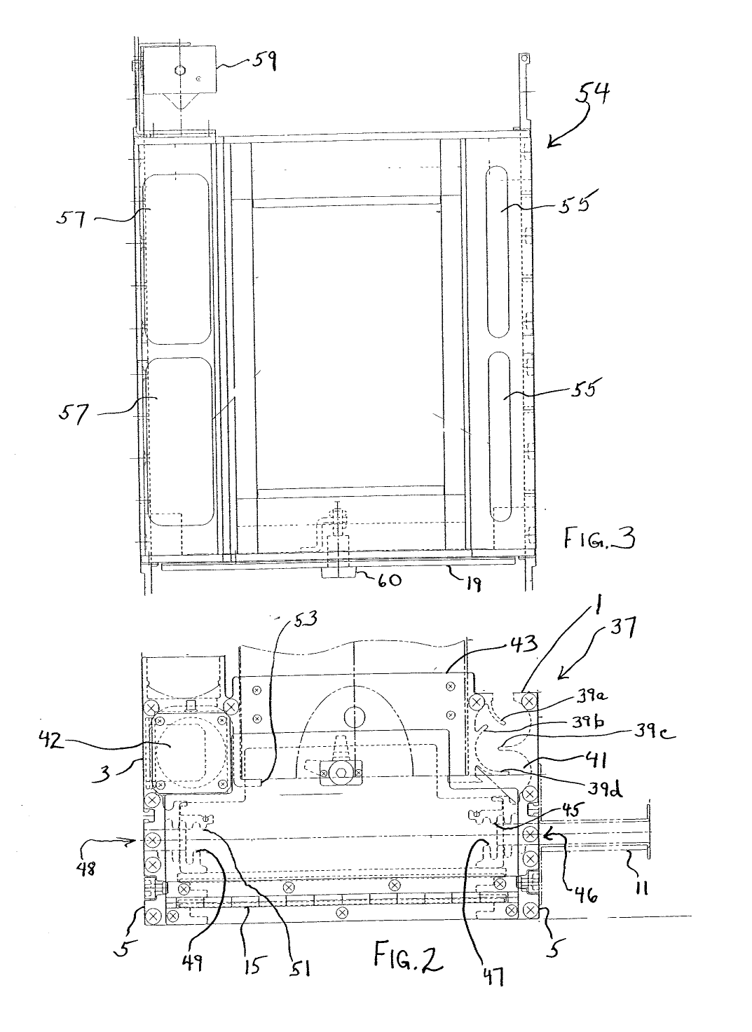

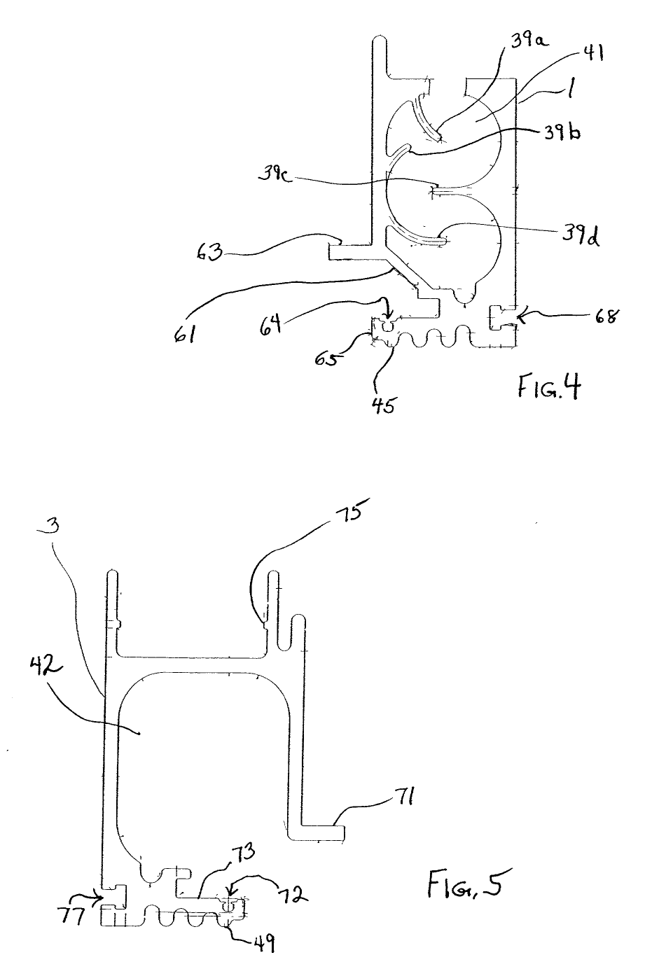

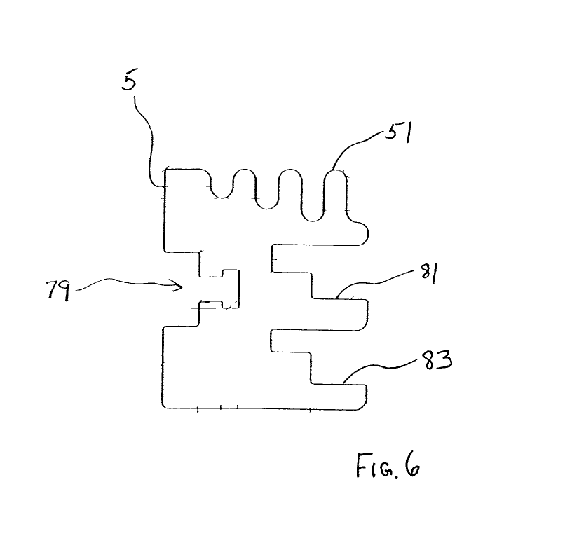

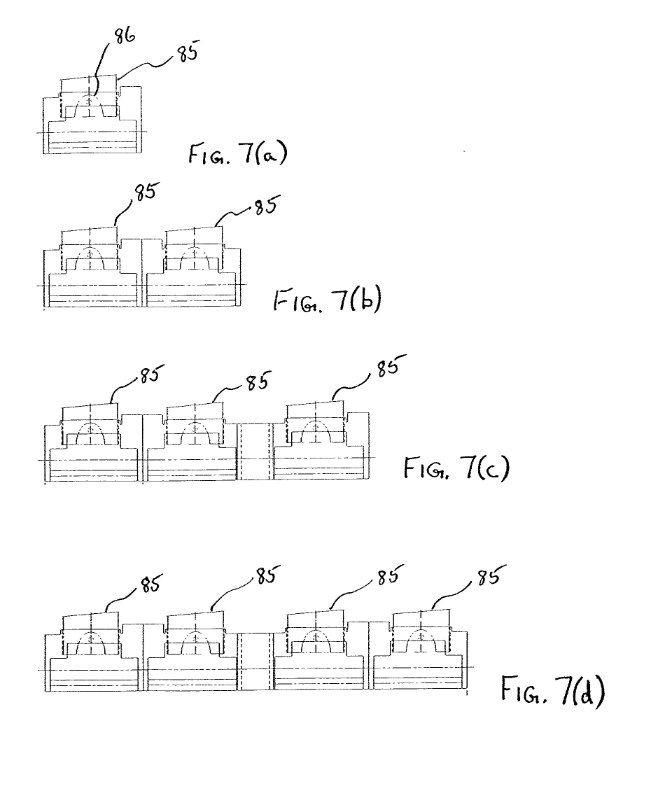

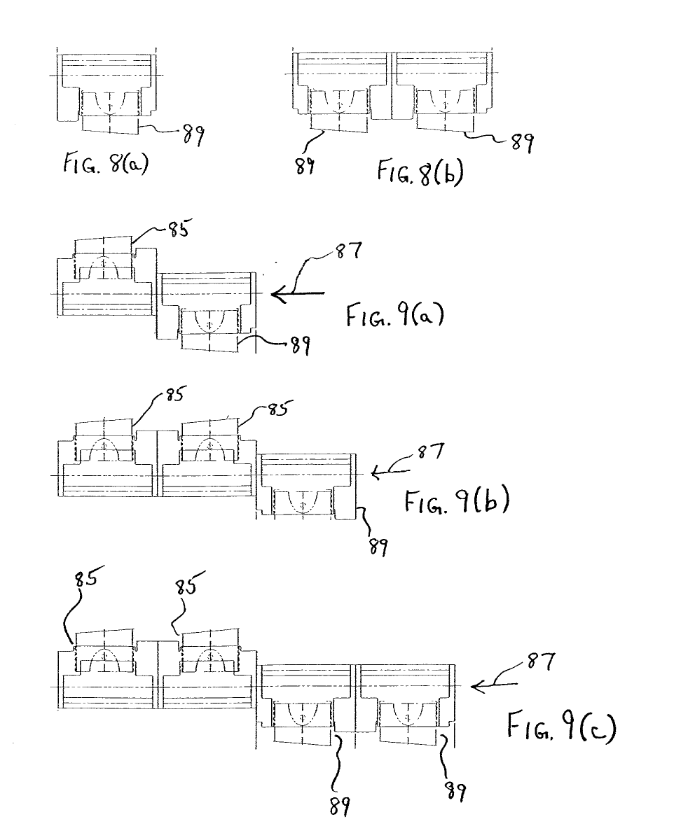

FIG. 1 is an exploded perspective view of a housing according to the present invention which would, for example, be adapted to support lamps positioned over a web. The apparatus shown includes air intake extrusion 1 and air exhaust extrusion 3, and bottom extrusions 5, 5. A lamp would be supported by lamp support 6 respectively on air intake extrusion 1 (lamp support 6 of the air intake extrusion is not shown in FIG. 1) and air exhaust extrusion 3. Also shown is optional quartz sheet holder 7 for holding quartz sheet 9 (to form a quartz window between the web and lamps), supported by channel 8 shown in air exhaust extrusion 3 (and a corresponding channel (not shown) on air intake extrusion 1). Optional external inlet snout 11 and optional external outlet snout 13 are shown in FIG. 1. As mentioned in the foregoing, due to the sinusoidal boundary surfaces forming internal snouts according to the present invention, these external snouts are not mandatory according to the present invention (while being mandatory in conventional structures) but optional for more effective trapping of light. These external inlet and outlet snouts are known in the art.

Also shown in FIG. 1 is heat shield 15; this heat shield fits on supports 16, 16 provided in each of bottom extrusions 5, 5. Note that heat shield 15 and quartz holder 7 can easily be slid in and out from the extrusions, being placed in respective channels, and thus are easily removable at the location of use for replacement and/or change.

Also shown in FIG. 1 is end plate 17 and door 19. Door 19 can be opened (using door hinge 21) to expose inner portions of the housing (including, for example, the curing chamber (irradiation location), heat shield 15 and quartz holder 7) to the outside.

Also shown in FIG. 1 is air intake screen 25 and air exhaust screen 23; these screens are RF screens, provided in order to avoid leakage from the housing of radio frequency radiation, dangerous to the health of, for example, operators of the processing apparatus.

Shown in end plate 17 is hole 18; this hole 18 is covered by cover 27. The hole 18 can be utilized to provide, for example, an RF detector. Such RF detector is desirable, for example, for apparatus using microwave lamps, to detect RF screen failure. The RF detector can be inside end plate 17 or outside thereof.

Also shown in FIG. 1 is tab 29, inside of door 19, and heat shield 31 for the inside of door 19. Heat shield 31 provides heat deflection, and the tab allows for thermal expansion and air flow cooling between heat shield 31 and door 19. A similar tab and heat shield arrangement can be provided for end plate 17, to provide desired cooling/protection of end plate 17. As for the heat shield tabs and heat shield for end plate 17, note respectively the components represented by reference characters 33 and 35, in FIG. 1.

Also shown in FIG. 1 is optional air exhaust top exit and rear exit 28. This covers the top of the air exhaust duct in air exhaust extrusion 3.

FIG. 2 shows in cross section the housing and lamp, forming lamp module 37, according to an embodiment of the present invention. Shown in FIG. 2 in more detail than in FIG. 1, is air intake extrusion 1 having air intake duct 41, the air intake duct having vanes 39a, 39b, 39c and 39d therein. These vanes extend from both sides of air intake duct 41, and overlap in all directions, including in plan view, such that there is no straight line through air intake duct 41 without contacting a vane; the vanes act as a light trap in the air intake duct. Also seen in FIG. 2 is lamp 43.

Sinusoidal surface 45 for the inlet 46, for material entering lamp module 37 to be, e.g., cured by light from lamp 43, preferably has a surface which has no flat portions, yet which is not so sharp as to damage the material support (e.g., conveyor or web) where the conveyor or web comes in contact with surface 45. Reference character 47 presents the sinusoidal surface for inlet 46, forming part of bottom extrusion 5.

On the other side of FIG. 2, shown is gas exhaust extrusion 3 having gas exhaust duct 42, and having sinusoidal surface 51 forming the outlet surface for outlet 48. On this other side of FIG. 2 is shown sinusoidal surface 49, forming part of bottom extrusion 5 forming the bottom part of the outlet surface. Also shown in FIG. 2 is reference character 53, which is part of the support for the lamps, and formed as part of air exhaust extrusion 3. A corresponding support surface for the lamp is provided extending from air intake extrusion 1.

FIG. 3 shows a top plan view of housing 54 according to the present invention. Shown in FIG. 3 are air intake slots 55, 55 and air exhaust slots 57, 57, wherein respectively air is introduced into air intake duct 41 and air exits from air exhaust duct 42 provided in air exhaust extrusion 3. Also shown in FIG. 3 is latch 60 for door 19, for easy access to the interior of housing 54. Further shown is RF detector 59, for detecting leakage of radio frequency radiation and, for example, detecting damage to the RF screen.

FIGS. 4 and 5 schematically respectively show cross-sections of air intake extrusion 1 and air exhaust extrusion 3, in more detail than in FIG. 1. FIG. 4 shows vanes 39a-39d in air intake duct 41. The uppermost vane, vane 39a, is a most important vane for eliminating straight line paths of light through air intake duct 41 and at least reducing light leakage from the housing, while providing good air flow. Also shown in FIG. 4 is support 65 for quartz plate 9 on quartz holder 7, and support 63 for the lamps. In FIG. 5 are shown corresponding support 71 for the lamps and support 73 for the quartz holder 7 holding quartz plate 9. Supports 71 and 63 provide a stable support for the series of lamps (e.g., a row of lamps) for a lamp module, and supports 73 and 65 provide a firm and stable support for the quartz window.

Also shown respectively in FIGS. 4 and 5 are grooves 64 and 72, each for holding a, e.g., sealing gasket to seal off the area where the web passes (that is, the path of the web) from upper regions of the housing which, e.g., support the lamps. According to this further aspect of the present invention, wherein the region for passage of the web can be sealed off from other regions, irradiation of the material being treated (e.g., cured) can be performed under an inert gas blanket.

According to various aspects of the present invention, quartz holder 7 can have air holes therethrough, whereby cooling gas while has passed through air intake duct 41 enters the housing above the quartz plate 9 and passes through holes in quartz holder 7 to the region around the support (e.g., web) holding the material irradiated, so as to cool such region including the web and housing components adjacent such region.

Also seen in FIGS. 4 and 5 respectively are grooves 68 and 77 on air intake extrusion 1 and air exhaust extrusion 3 for attachment to an adjacent member of adjacent lamp systems. For example, a bolt and nut combination can be provided respectively in air intake extrusion 1 shown in FIG. 4 and air exhaust extrusion 3 shown in FIG. 5 to fasten air intake and exhaust extrusions of adjacent housings to each other, providing adjacent rows of lamps for further irradiation of material treated.

Also shown in FIG. 4 is bridge 61. This bridge 61 is maintained during extrusion in forming air intake extrusion 1, to provide reinforcement for the extrusion. Holes or slots can be provided through bridge 61 at the time holes or slots 55 for air intake are provided in the top of air intake extrusion 1, e.g., by machining, so as to provide the necessary passageway for cooling gas from outside the housing to inside the housing during operation of the lamps.

Also shown in FIG. 5 is air exhaust duct 42; air is exhausted from the irradiation location through air exhaust duct 42 and slots 57 for air exhaust.

FIG. 6 shows bottom extrusion 5 for use as part of the housing according to the present invention. As can be appreciated, according to various aspects of the present invention two bottom extrusions 5 can be utilized, with, for example, heat shield 15 extending therebetween. As another aspect of the present invention, and not shown, a single bottom extrusion is provided extending across an entirety of the bottom of the housing. Shown in FIG. 6 are channels 81 and 83, which act as supports for louvers, chill beds, heat shields, etc., provided beneath the web, as discussed previously. These provide for adjustable and selectable mounting of components by a customer. Also shown in FIG. 6 is groove 79, provided at an outside of bottom extrusion 5 and which can be connected with a corresponding groove in an adjacent part of an adjacent housing, to provide firm connection between adjacent housings through which pass, for example, a single web.

Components such as chill beds, louvers, heat shields, etc., which can be provided on supports 81 and 83 are known in the art; for example, the chill beds can be made of stainless steel, as known in the art.

Shown in FIGS. 7(a)-7(d) are various combinations of modules according to the present invention. FIG. 7(a) shows a single module 85 with a row of lamps each within, e.g., a respective parabolic reflector 86. FIG. 7(b) shows two rows of modules 85, 85, which can be fastened adjacent to each other. FIG. 7(c) shows three rows of modules, two being adjacent to each other and the third being spaced from the other two; and FIG. 7(d) shows four modules 85, 85, 85 and 85, with two modules, of a group of two, respectively being attached to each other, the first group of two being spaced from the second group of two. FIGS. 7(a)-7(d) all show top cure structures, that is, the light is irradiated only on an upper surface of a material being irradiated (for example, a coating on an upper surface of a web).

FIGS. 8(a) and 8(b) show, respectively, a single bottom cure module 89 and two bottom cure modules 89, 89, the two bottom cure modules 89, 89 in FIG. 8(b) being adjacent to each other and which can be fastened to each other. As can be appreciated, in order to prevent the lamps from dropping off of the housing in a bottom cure structure, structure to hold the lamps on the lamp support is necessary. For example, and not to be limiting, C-brackets can be bolted to the lamp and lamp support, to allow the lamp to hang upside down.

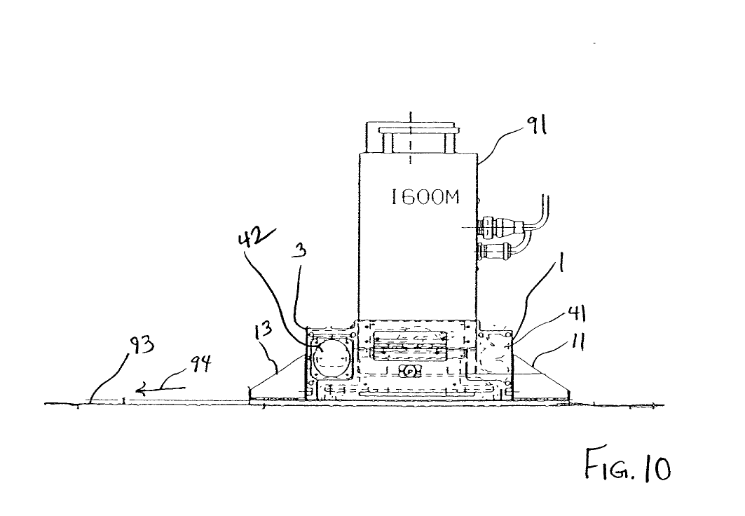

Shown in FIGS. 9(a)-9(c) are mixtures of top cure and bottom cure modules through which pass a single web, in the direction as represented by arrow 87. FIG. 9(a) shows a single top cure module and a single bottom cure module, which can be fastened to each other through grooves as discussed previously. FIG. 9(b) shows two top cure modules 85, 85 and a single bottom cure module 89; and FIG. 9(c) shows two top cure modules 85,85 and two bottom cure modules 89, 89 all fastened together, providing irradiation of, e.g., coatings to be cured on both the upper and lower surfaces of a web. Thus, coatings on opposed surfaces of a web material can be irradiated for, e.g., curing, using a single pass of the web.

FIG. 10 shows another embodiment of the present invention, having lamp assembly 91 supported on air intake extrusion 1 and air exhaust extrusion 3. Seen in FIG. 10 are air exhaust duct 42 and air intake duct 41. Also shown in FIG. 10 are external inlet and outlet snouts 11 and 13, respectively. Also shown in FIG. 10 is top 93 of a web or belt supporting the material irradiated, the web traveling in the direction shown by arrow 94.

As can be appreciated in FIG. 10, there is no bottom extrusion; the unit in FIG. 10 is a retrofit unit, and can be provided on top of an already existing structure beneath top 93 of the web, so that existing structures can be utilized while still enjoying advantages achieved according to the present invention.

The extrusion parts according to the present invention, constructed together to form the member and from such member the housing according to the present invention, can be formed by conventional extrusion techniques known in the art. The extrusion parts can be attached to each other by known techniques (e.g., bolted to each other) to form the member. Components or parts of the member, such as the air intake extrusion, air exhaust extrusion and bottom extrusion, can be formed of various materials such as aluminum-containing materials, including aluminum alloys and aluminum per se.

Lamp modules or assemblies according to the present invention can be used as conventional modules or assemblies are used, for example, for curing light-curable (for example, ultraviolet light-curable, infrared light-curable and visible light-curable) resins. As an illustrative technique, this method can be used to cure a resin material by steps including providing at least one lamp module, according to the present invention, at a conveying structure; providing a resin material, to be cured, on the conveying structure (for example, as a coating on a web); conveying the resin material on the conveying structure (for example, as a coating of resin material on a web) to a location in the lamp module where light from the lamps is irradiated on the resin material; and irradiating light from the lamps on the resin material, so as to cure the resin material.

Illustratively, lamps used can be ultraviolet light-producing lamps, such as microwave-powered electrodeless ultraviolet light-producing lamps, with the resin material being an ultraviolet light-curable resin. As one feature of the present invention, a plurality of lamps can be provided in a single row, with the housing extending across an entire width of a web having the resin material as a coating thereon. With the excellent flexibility according to the present invention, component parts for providing the housing can be extruded initially at a single predetermined length and can be cut later so as to have a module length consistent with the width of the web of the customer, so that the lamps extend across an entire width of the web.

The present invention has application in various technological areas, where light (for example, ultraviolet light, visible light and/or infrared light) is irradiated on a material to be treated. For example, the present invention has technological applicability in curing resin materials which are photo-curable (for example, ultraviolet light-curable resins, visible light-curable resins and/or infrared light-curable resins), particularly where the resin material is provided as a coating on a web material and is photo-cured as a coating.

Many different embodiments of the present invention may be constructed without departing from the spirit and scope of the invention. It should be understood that the present invention is not limited to the specific embodiments described in this specification. To the contrary, the present invention is intended to cover various modifications and equivalent arrangements included within the spirit and scope of the appended claims.

What is claimed is:

1. A gas intake extrusion part for a housing for at least one lamp for irradiating material, the part having gas intake structure and support for at least one lamp, the gas intake structure including a gas intake duct, the part being formed by extrusion.

2. A gas exhaust extrusion part for a housing for at least one lamp for irradiating material, the part having gas exhaust structure and support for at least one lamp, the gas exhaust structure including a gas exhaust duct, the part being formed by extrusion.

3. A bottom extrusion part for a housing for at least one lamp for irradiating material, the part having a support for at least one of a heat shield or heat removing device, such that said at least one of the heat shield or heat removing device can be removably changed on the support, the part being formed by extrusion.

4. A member for providing a housing for at least one lamp for irradiating material, the member extending in a lengthwise direction, comprising:
a support for at least one lamp, said support extending in the lengthwise direction;
an inlet and an outlet for said material, respectively positioned at a front and at a rear of the member, in a direction transverse to the lengthwise direction, the inlet and the outlet being positioned such that the material when passing from the inlet to the outlet on a path, can be irradiated by radiation from the at least one lamp at an irradiating location within the member, each of the inlet and the outlet for the material extending in the lengthwise direction; and
gas intake structure and gas exhaust structure respectively for supplying and removing a cooling gas, the gas intake and gas exhaust structures extending in the lengthwise direction,
wherein the member is a structure formed of parts formed by extrusion.

5. The member according to claim 4, wherein one of the gas intake structure and the gas exhaust structure is provided at the front of the member, and the other of the gas intake structure and gas exhaust structure is provided at the rear of the member.

6. The member according to claim 4, further comprising a second support for removably supporting a device for removing heat or a heat shield, the path between the inlet and the outlet being between the support for the at least one lamp and the second support.

7. The member according to claim 6, which removably supports a device for removing heat.

8. The member according to claim 6, wherein each of the inlet for the material and the outlet for the material includes an opening extending inwardly of the member, each opening being defined by a boundary surface above and below the opening, each boundary surface having a sinusoidal shape.

9. The member according to claim 8, wherein each boundary surface is coated with a flat black paint.

10. The member according to claim 8, wherein said boundary surface is provided by extrusion.

11. The member according to claim 8, wherein the member further includes a third support for removably supporting a quartz sheet which is transparent to radiation from the at least one lamp, said third support being positioned between the support for the at least one lamp and the path for the material, the third support being provided by extrusion.

12. The member according to claim 11, wherein the gas intake structure includes a duct having a plurality of vanes extending into the duct from opposed regions of the duct such that, in plan view, the vanes overlap each other.

13. The member according to claim 12, wherein surfaces of the vanes are painted with a flat black paint.

14. The member according to claim 12, wherein the vanes overlap each other such that all straight line paths through said duct contact at least one vane.

15. The member according to claim 14, wherein the plurality of vanes act as traps for radiation from the lamps.

16. The member according to claim 14, wherein each of the gas intake structure and gas exhaust structure has a ridge for holding an RF screen to retain radio frequency waves, generated by the at least one lamp, from exiting the housing formed from the member.

17. The member according to claim 16, wherein the ridge is formed by grooves in the air intake and air exhaust structures.

18. The member according to claim 17, wherein the grooves in the air intake structure are formed by the vanes.

19. The member according to claim 16, wherein the vanes are formed by extrusion.

20. The member according to claim 16, wherein the member has grooves along outer sides thereof, extending in said lengthwise direction, for attaching to each other at least two housings each made from a respective member, such that the at least two housings can be attached to each other side-by-side whereby the material can pass through the at least two housings in series.

21. The member according to claim 4, wherein said member is made of an aluminum-containing material.

22. The member according to claim 21, wherein said member is made of aluminum.

23. The member according to claim 4, wherein each of the inlet for the material and the outlet for the material includes an opening extending inwardly of the member, each opening being defined by a boundary surface above and below the opening, each boundary surface having a sinusoidal shape.

24. The member according to claim 4, wherein the member further includes a third support for removably supporting a quartz sheet which is transparent to radiation from the at least one lamp, said third support being positioned between the support for the at least one lamp and the path for the material, the third support being provided by extrusion.

25. The member according to claim 4, wherein the gas intake structure includes a duct having a plurality of vanes extending into the duct from opposed regions of the duct such that, in plan view, the vanes overlap each other.

26. The member according to claim 25, wherein the vanes overlap each other such that all straight line paths through said duct contact at least one vane.

27. The member according to claim 4, wherein each of the gas intake structure and gas exhaust structure has a ridge for holding an RF screen to retain radio frequency waves, generated by the at least one lamp, from exiting the housing formed from the member.

28. The member according to claim 4, wherein the member has grooves along outer sides thereof, extending in said lengthwise direction, for attaching to each other at least two housings each made from a respective member, such that the at least two housings can be attached to each other side-by-side whereby the material can pass through the at least two housings in series.

29. The member according to claim 4, wherein said parts formed by extrusion include at least three extruded parts, each extending in the lengthwise direction, the at least three extruded parts being a gas intake extrusion, a gas exhaust extrusion and at least one bottom extrusion, the gas intake extrusion having the gas intake structure therein and the gas exhaust extrusion having the gas exhaust structure therein; wherein the at least three extruded parts are fastened together to provide the member, the gas intake extrusion and gas exhaust extrusion both being fastened to the at least one bottom extrusion, above the at least one bottom extrusion, at opposed sides of the at least one bottom extrusion transverse to the lengthwise direction; and when the gas intake extrusion and gas exhaust extrusion are fastened to the at least one bottom extrusion, the inlet and outlet for said material are provided between the at least one bottom extrusion and the gas intake and gas exhaust extrusions and the support for the at least one lamp is provided by the gas intake and gas exhaust extrusions.

30. The member according to claim 29, further comprising a second support in the at least one bottom extrusion, for removably supporting a device for removing heat or a heat shield.

31. The member according to claim 29, further comprising a third support, provided by the gas intake extrusion and gas exhaust extrusion when both are fastened to the at least one bottom extrusion, for removably supporting a quartz sheet which is transparent to radiation from the at least one lamp.

32. A housing for at least one lamp for irradiating material, comprising:
the member according to claim 4; and
end plates covering both ends of the member.

33. The housing according to claim 32, wherein at least one of the end plates is removable.

34. The housing according to claim 32, wherein at least one of the end plates includes a heat deflector on a surface thereof facing inside the member.

35. The housing according to claim 32, wherein the heat deflector is mounted on a tab on the surface of said at least one of the end plates, facing inside the member.

36. A housing for at least one lamp for irradiating material, comprising:
the member according to claim 4, which has been cut to a specified length to provide a cut member; and
end plates covering both ends of the cut member.

37. A housing for at least one lamp for irradiating material, comprising:
the member according to claim 29; and
end plates covering both ends of the member.

38. A housing for at least one lamp for irradiating material, comprising:
the member according to claim 24; and
end plates covering both ends of the member.

39. A housing for at least one lamp for irradiating material, comprising:
the member according to claim 25; and
end plates covering both ends of the member.

40. A housing for at least one lamp for irradiating material, comprising:
the member according to claim 24; and
end plates covering both ends of the member.

41. A housing for at least one lamp for irradiating material, comprising:
the member according to claim 23; and
end plates covering both ends of the member.

42. A housing for at least one lamp for irradiating material, comprising:
the member according to claim 20; and
end plates covering both ends of the member.

43. A housing for at least one lamp for irradiating material, comprising:
the member according to claim 16; and
end plates covering both ends of the member.

44. A housing for at least one lamp for irradiating material, comprising:
the member according to claim 14; and
end plates covering both ends of the member.

45. A housing for at least one lamp for irradiating material, comprising:
the member according to claim 12; and
end plates covering both ends of the member.

46. A housing for at least one lamp for irradiating material, comprising:
the member according to claim 11; and
end plates covering both ends of the member.

47. A housing for at least one lamp for irradiating material, comprising:
the member according to claim 8; and
end plates covering both ends of the member.

48. A housing for at least one lamp for irradiating material, comprising:
the member according to claim 6; and
end plates covering both ends of the member.

49. A lamp module for irradiating material, comprising:
the housing according to claim 32; and
at least one lamp supported by said support for at least one lamp.

50. The lamp module according to claim 49, which includes a plurality of lamps supported by said support, the plurality of lamps being positioned in a single row extending in said lengthwise direction.

51. The lamp module according to claim 49, wherein said at least one lamp is at least one ultraviolet light-producing lamp.

52. The lamp module according to claim 51, wherein said at least one ultraviolet light-producing lamp is at least one microwave-powered electrodeless ultraviolet light-producing lamp.

53. The lamp module according to claim 49, wherein the support for the at least one lamp is at the top of the member, and the at least one lamp is positioned on the support for the at least one lamp.

54. The lamp module according to claim 49, wherein the support for the at least one lamp is at the bottom of the member, and the at least one lamp is fastened to the support for the at least one lamp.

55. Lamp system comprising:
the lamp module according to claim 49; and
conveying structure to support and move the material from the inlet to the outlet through the irradiating location.

56. Lamp system according to claim 55, wherein the conveying structure is a web.

57. Lamp system according to claim 56, adapted to irradiate a coating of the material on said web.

58. Lamp system comprising:
a plurality of lamp modules according to claim 51; and
conveying structure to support and move the material from the inlet to the outlet, through the irradiating location, of each of the plurality of lamp modules in series,
wherein the plurality of lamp modules are placed side-by-side in the direction that the conveying structure moves the material.

59. Lamp system according to claim 58, wherein at least two of the plurality of lamp modules are fastened to each other side-by-side.

60. Lamp system according to claim 58, wherein the plurality of lamp modules include at least one lamp module having the support for the at least one lamp above the conveying structure and at least one lamp module having the support for the at least one lamp below the conveying structure.

61. A method of making the member of claim 29, comprising:
extruding a first body of material of the member through an extruder to form said gas intake extrusion;
extruding a second body of material of the member through an extruder to form said gas exhaust extrusion;
extruding at least one third body of material of the member through an extruder to form said at least one bottom extrusion; and
fastening said gas intake extrusion and said gas exhaust extrusion to said at least one bottom extrusion, with the gas intake extrusion and the gas exhaust extrusion being positioned above the at least one bottom extrusion and at opposed sides thereof, to thereby provide said member.

62. The method according to claim 61, wherein the fastening is performed by bolting each of the gas intake extrusion and the gas exhaust extrusion to the at least one bottom extrusion.

63. The method according to claim 61, wherein after extruding the first body and the second body, slots are formed in the extruded first body and the extruded second body so as to expose the gas intake structure and gas exhaust structure to the outside.

64. The method according to claim 63, wherein in extruding the first body a bridge of material is maintained at an end of the gas intake structure which extends to an interior of the first body, and the bridge of material is thereafter machined to expose the gas intake structure at interior locations of the first body.

65. A method of curing a resin material, comprising:
providing the lamp system according to claim 55;
providing a resin material, to be cured, on the conveying structure; and
conveying the resin material on the conveying structure to the irradiating location and irradiating the resin material with radiation from the at least one lamp, so as to cure the resin material.

66. The method according to claim 65, wherein the at least one lamp is at least one ultraviolet light-producing lamp, and the resin material is an ultraviolet-light curable resin material.

67. The method according to claim 66, wherein the at least one ultraviolet light-producing lamp is at least one microwave-powered electrodeless ultraviolet light-producing lamp.

68. The method according to claim 65, wherein the conveying structure is a web, and the step of providing the resin material includes forming a coating of the resin material on the web.

69. The method according to claim 68, wherein the lamp module includes a plurality of lamps, which extend across an entire width of the web.
